(19) United States
(12) Patent Application Publication
(10) Pub. No.: US 2015/0122705 A1
(43) Pub. Date: May 7, 2015

(54) METHOD AND APPARATUS FOR SORTING AND UPGRADING MINED MATERIAL

(71) Applicant: Technological Resources Pty Limited, Perth, Western Australia (AU)

(72) Inventor: Dewetia Latti, Bundoora (AU)

(21) Appl. No.: 14/361,779

(22) PCT Filed: Nov. 30, 2012
(86) PCT No.: PCT/AU2012/001469

§ 371 Date: May 30, 2014

(30) Foreign Application Priority Data
Dec. 1, 2011 (AU) 2011905039

(51) Int. Cl. B07C 5/344

(52) U.S. Cl. CPC B07C 5/344
USPC 209/10; 209/555

(57) ABSTRACT

A method of sorting a parcel of ore comprising the steps of first sorting the parcel of ore into one of at least two grades based on a characteristic of the parcel of ore, and a second sorting step wherein the parcel of ore is further sorted.

### TECHNICAL FIELD

The present invention relates to a method and apparatus for sorting mined material. Embodiments of the invention find particular, but not exclusive, use in the upgrading of mined material, such as copper, nickel and iron ores.

### BACKGROUND ART

The following description of the background art refers specifically to copper ores and the extraction of copper metal from copper ore. It will be understood that the description of copper ore sorting, extraction technologies and prices are provided to better contextualise the broader inventive concept described herein, but are not intended to be limiting on the broader inventive concept.

Moreover, any references to specific technologies, methodologies, apparatuses, devices, etc. are not admissions that the technologies, methodologies, apparatuses, devices, etc. form part of the common general knowledge.

While the amount of copper available on Earth is vast, only a small fraction of the copper present on Earth can be extracted from copper ores in an economically viable manner. The economic viability of copper recovery is driven by a complex combination of factors, including but not limited to the market price of copper and the efficiency and cost of mining, upgrading and recovery technologies.

In the year 2011, taking into account 2011 copper prices and 2011 technology, copper ore that contains less than approximately 0.6% copper cannot be mined, upgraded, recovered and sold at a profit using the conventional methods of grinding and flotation. This contrasts with copper ores that were mined in the 1980s, when the commercial cut-off was an ore that contained approximately 5-6% copper.

In other words, over time, the quality of the copper ores being mined has decreased dramatically. With the average concentration of copper being so low in ores currently being mined, the amount of resources (time, effort and financial input) required to upgrade the copper ore and recover the copper metal is ever increasing.

As such, the upgrading of copper ore and the recovery of copper metal from upgraded ore is becoming a more cost and resource intensive process and there is a need to find better processing methodologies that more efficiently upgrade copper ore and consequently more efficiently recover copper metal from the ore.

It is in the abovementioned context that the invention described and defined herein was developed.

### SUMMARY OF INVENTION

In a first aspect, there is provided a method of sorting a parcel of ore comprising the steps of first sorting the parcel of ore into one of at least two grades based on a characteristic of the parcel of ore, and a second sorting step wherein the parcel of ore is further sorted.

The second sorting step may comprise the intermediate step of dividing the parcel into at least two sub-parcels of ore and sorting at least one of the at least two sub-parcels. In this embodiment, the second sorting step includes the step of classifying the parcel of ore or at least one of the at least two sub-parcels of ore into one of a plurality of grades. Moreover, the second sorting step may further comprise the step of providing at least one of the at least two sub-parcels to the first sorting step.

In one embodiment, the intermediate step of dividing the parcel into at least two sub-parcels includes the step of determining at least one of the type of ore and the mineralogy of the ore, and dividing the parcel on the basis of the determination.

Moreover, the step of determining the at least one type of ore and the mineralogy of the ore may comprise the further step of utilising an algorithm to determine at least one of the type of ore and the mineralogy of the ore.

The algorithm may utilise a predetermined database of values as an input to determine the required sub-division of the parcel. The algorithm may further utilise at least one of the size of the parcel of particles and a speed at which the parcel of particles is progressing along a conveyor belt as inputs to determine the required sub-division of the parcel.

In one embodiment, the second sorting step comprises the step of re-sorting at least one of the at least two sub-parcels utilising the first sorting step.

In one embodiment, the plurality of grades includes a barren grade, an intermediate grade and a high grade. In the context of copper ores low grade collection includes copper ore with a copper concentration of about or below 0.3% by weight. A high grade collection includes copper ore with a copper concentration of about or above 0.6% by weight. An intermediate grade collection includes copper ore with a copper concentration of between approximately 0.3% to 0.6% by weight.

Where the ore is of a high grade, the sorting step includes the further step of sending the ore to a recovery stage.

Where the ore is of a barren grade, the sorting step includes the further step of sending the ore to a tailings storage area.

The first sorting step may include exposing the at least one parcel of ore to an electromagnetic field and measuring the resultant emitted electromagnetic radiation from the parcel of ore, wherein the resultant electromagnetic radiation is indicative of a characteristic of the parcel of ore. The second sorting step may include at least one of utilising a magnetic resonance technique, a microwave technique and a radio frequency technique.

The characteristic of the ore may be at least one of the type of ore and the relative concentration of a metal in the ore.

In one embodiment, the ore is a copper containing ore.

In one embodiment, the size of the parcel of ore or the at least two sub-parcels of ore are dependent on at least one characteristic. The at least one characteristic is a function of the average grade of a plurality of parcels of ore.

In a second aspect, the present invention provides an apparatus for sorting a parcel of ore comprising a first sorting device arranged to sort a parcel of ore into one of at least two grades based on a characteristic of the parcel of ore, and a second sorting device wherein the parcel of ore is further sorted.

The apparatus may further comprise a parcel definition device arranged to divide the parcel into at least two sub-parcels of ore, wherein the second sorting device sorts at least one of the at least two sub-parcels. The second sorting device may classify at least one of the at least two sub-parcels of ore into one of a plurality of grades.

The parcel definition device may be in communication with at least one sensor arranged to determine at least one of the type of ore and the mineralogy of the ore, wherein the parcel is divides on the basis of the determination. The parcel definition device may further be in communication with at least one processor that utilises an algorithm to determine at least one of the type of ore and the mineralogy of the ore.

In one embodiment, the parcel definition device is in communication with at least one database which is accessible via the at least one processor, the database including a predetermined database of values utilised by the processor as an input to determine the required sub-division of the parcel.

In one embodiment, the parcel definition device is in communication with at least one additional sensor arranged to provide data to the processor, the at least one additional sensor providing data indicative of at least one of the size of the parcel of particles and a speed at which the parcel of particles is progressing along a conveyor belt, wherein the data is utilised as an input by the processor to determine the required sub-division of the parcel.

The second sorting device may be arranged to feed back at least one of the at least two sub-parcels to the first sorting device.

The first sorting device may include a magnetic resonance system arranged to expose the at least one parcel to an electromagnetic field and measure the resultant emitted electromagnetic radiation from the parcel of ore, wherein the resultant electromagnetic radiation is indicative of a characteristic of the parcel of ore.

The second sorting device may be one of a magnetic resonance sorting device, a microwave sorting device and a radio frequency sorting device.

The apparatus may further comprise a parcel definition device arranged to alter the number of particles in the parcel of ore dependent on at least one parameter. The at least one parameter is a function of the average grade value over a predetermined period of time.

In a third aspect, there is provided a mining circuit including an apparatus in accordance with the second aspect of the invention.

In a fourth aspect, there is provided a mine including an apparatus in accordance with the second aspect of the invention.

In a fifth aspect, the present invention provides a method of sorting copper ore comprising the steps of exposing a plurality of particles of copper ore to a magnetic field and measuring the resultant emitted electromagnetic radiation to determine at least one of the type of copper ore or the relative concentration of copper in the copper ore of the plurality of particles, and sorting the plurality of particles of copper ore on the basis of the determination.

In one embodiment, the method includes the further step of classifying the plurality of particles into one of a plurality of grades. Moreover, the sorting step may include the further step of performing an additional sorting step if the plurality of particles of copper ore is of an intermediate grade.

In one embodiment, the additional sorting step comprises iterating the method steps of the fifth aspect of the invention utilising the plurality of particles of copper ore of an intermediate grade.

In a sixth aspect, the present invention provides a copper ore sorting apparatus comprising a magnetic field generator arranged to expose a plurality of particles of copper ore to an electromagnetic field, a detector arranged to measure the resultant emitted electromagnetic radiation from the particles, and a processing device arranged to receive the measurement from the detector and determine at least one of the type of copper ore or the relative concentration of copper.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIGS. 1 and 2 are diagrams illustrating the components of a sorter arranged to sort copper ores in accordance with an embodiment of the invention; and

FIGS. 3 to 6 are diagrams illustrating example mining circuits for upgrading copper ores utilising a sorter in accordance with an embodiment of the invention.

### DESCRIPTION OF EMBODIMENTS

In the ensuing description, the embodiment described refers specifically to the upgrading of copper ore. It will be understood that the methodology and apparatus described herein may be applied to the upgrading of other ores, such as nickel or iron.

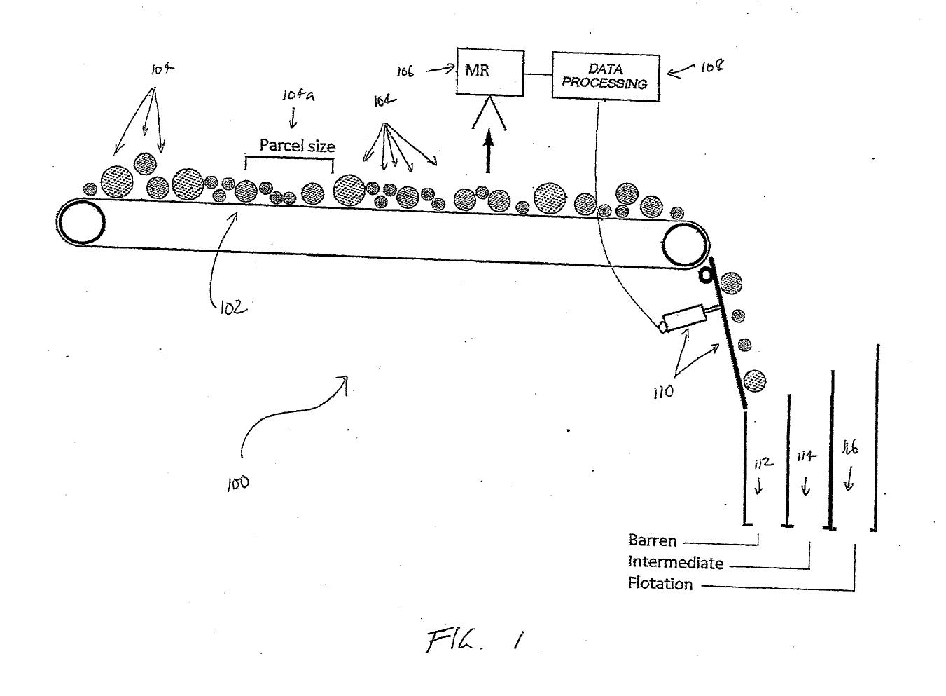

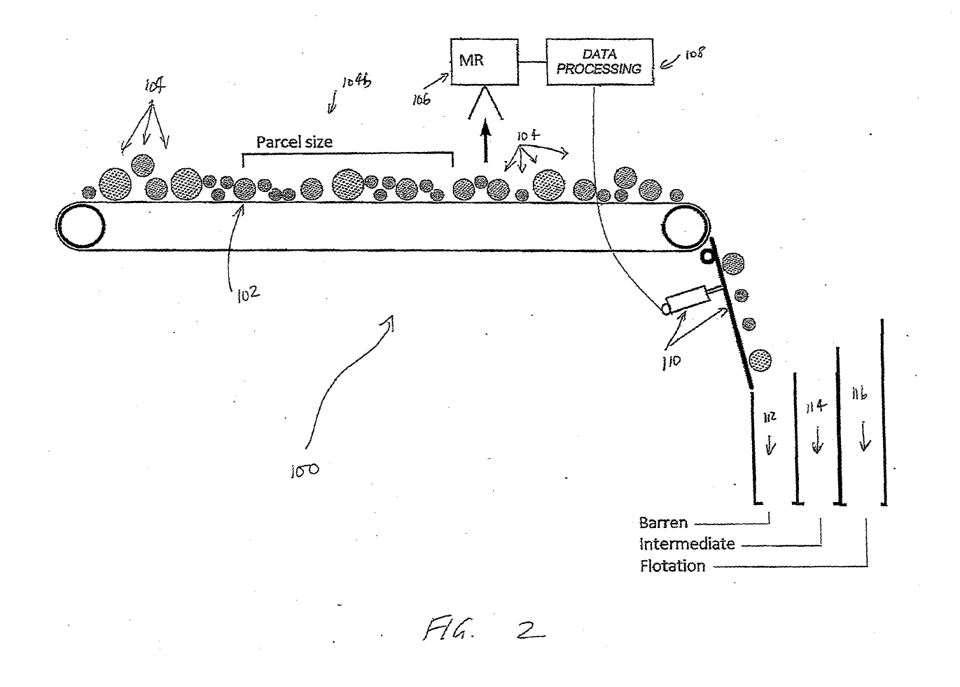

Referring to FIGS. 1 and 2, there is shown generally an apparatus (or component in an upgrading circuit) that is used to sort and thereby upgrade copper ore. The apparatus is arranged to carry out a number of steps in order to sort and upgrade copper ore that has been crushed into particles. The method steps include a first sorting step which sorts the parcel of ore into one of at least two grades based on a characteristic of the parcel of ore, and a second sorting step in which the parcel of ore is further sorted.

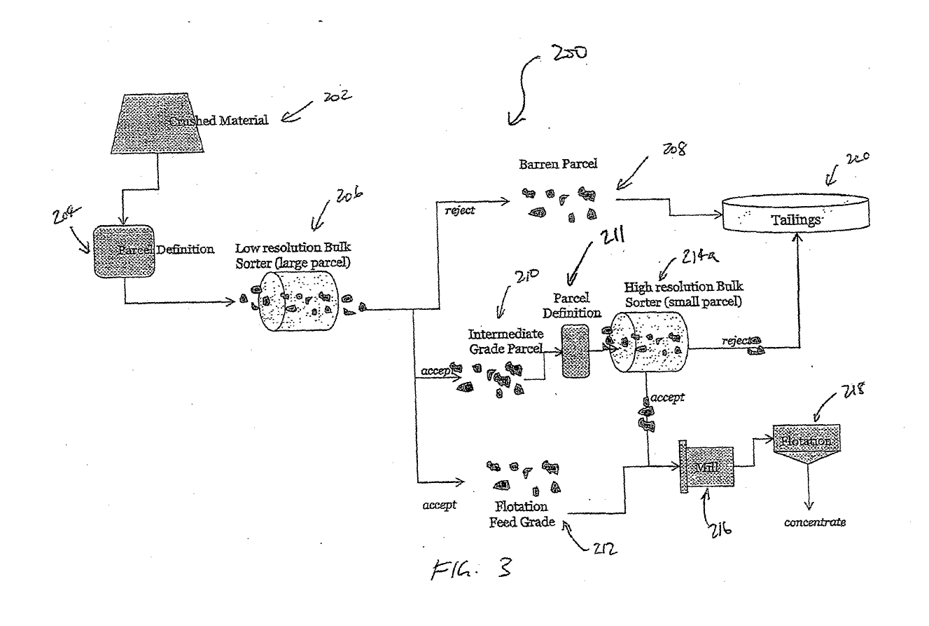

It will be understood that like numerals in FIGS. 1 and 2 denote like components, features or steps. Correspondingly, like numerals in FIGS. 3 to 6 correspond to like components, features or steps.

Referring in more detail to FIGS. 1 and 2, there is shown a sorter 100 in accordance with an embodiment of the invention. The sorters of FIGS. 1 and 2 are the type of sorters that are used as “bulk sorters” and form part of the broader inventive method and apparatus described herein.

The type of sorter shown at 100 is generally referred to in the art as a “bulk sorter”, as it is arranged to sort large amounts of ore and preferably in a continuous manner. The sorter 100 includes a conveyor belt 102 (or any other suitable ore transport device) arranged to convey particles of copper ore (generally denoted by numeral 104).

In the context of the present specification, the term “particle” may be understood to be synonymous with the term “fragment”, which is a term used by some persons skilled in the art. In the context of the present specification, a particle may be considered to be a piece of ore that has a diameter of approximately 15-25 mm (although some particles may be much larger). Accordingly, each particles may weigh anywhere from under 10 grams to several kilograms. However, in many commercial mining operations, mined material is crushed into particles that are generally between 5 and 200 grams in weight.

However, it will also be understood that the invention described herein can find application in the sorting of ‘fine’ particles (i.e. particles under 5 grams).

Correspondingly, the number of particles of copper ore 104 that can pass along conveyor belt 102 is a function of the capacity of the conveyor belt 102. Where the sorter 100 forms part of a mined material upgrade circuit, the number of particles of copper ore 104 that can pass along the conveyor belt may also be measured as a function of the capacity and characteristics of other components in the mined material upgrade circuit (examples of which are described in more detail later with reference to FIGS. 3 to 6).

The bulk sorter is arranged to sort a plurality of particles simultaneously. For the sake of clarity, the present specification refers to a plurality of particles as a “parcel of particles”. It will be understood that in the context of the present specification, the number of particles that constitute a parcel is a function of a number of variables, which can change depending on the specific implementation and mining circuit, and also with the type of ore. For example, copper ore generally has smaller particle sizes than iron ore. Moreover, different ores that contain the same metal may also have different parcel sizes. In the example of copper ores, monzonite ores and quartzite ores have different parcel sizes.

In more detail, the number of particles in a parcel may vary depending on a number of parameters, including the size of the particles, the capacity of each upgrading and recovery stage, the total amount of copper ore to be upgraded, or any other appropriate metric. The choice of appropriate metrics may take into account both technical and economic considerations. However, it will be understood that, generally, a parcel contains at least three (3) or more particles and preferably more than ten (10) particles.

Moreover, the size of a parcel may be defined by weight or by defining a parcel as being the plurality of particles that locate along an arbitrary section/length of the conveyor belt 102.

Where the number of particles in a parcel is defined by weight, the total weight for a parcel may be anywhere from approximately 1 kg to approximately 1 metric ton. Where the parcel size is defined as all the particles within an arbitrary length of the conveyor, the parcel size may vary from 0.1 m to 2 m. Obviously, this measurement is highly dependent on the density of particles on the conveyor and the width of the conveyor. A parcel may also be defined as the number of particles that pass a particular point on the conveyor over a given period of time.

In summary, irrespective of the metrics utilized to determine a parcel size, it will be understood that a parcel may be broadly defined as a plurality of particles. In turn, the actual number of particles that constitute a parcel depends on the specific parameters of the mining circuit and in turn, the specific parameters may be characterized by reference to individual or average particle size or weight, the characteristics of the conveyor belt, the characteristics of any other component in the mining circuit, or any combination thereof.

Referring to FIGS. 1 and 2, the parcel size indicated generally by numeral 104a in FIG. 1 is to be construed as a ‘smaller’ parcel size and the parcel size indicated generally by numeral 104b in FIG. 2 is a to be construed as a ‘larger’ parcel size. The representations of parcels 104a and 104b are provided for the purpose of more clearly describing the embodiments and broader inventive concepts defined herein and are not to be construed as limiting on the claimed invention.

The conveyor belt 102 is arranged, in the embodiments shown in FIGS. 1 and 2, to move each parcel of copper ore particles 104a or 104b into the effective scanning range of a magnetic resonance device 106.

In the context of the present specification, the term “magnetic resonance” refers to a physical phenomenon in which magnetic nuclei in atoms that constitute a material absorb and re-emit electromagnetic radiation in response to being placed in an electro magnetic field. By studying the peaks of the nuclear magnetic resonance spectra produced by the re-emission of electromagnetic radiation from atoms in a material, information can be discerned about the atomic structure and composition of the material.

Correspondingly, the term “magnetic resonance device” refers to a device that is capable of both emitting an appropriate electromagnetic field that is absorbed by a material to be studied and measuring the resultant re-emitted electromagnetic radiation to produce an output signal that can be interpreted by a person or a computing system. The output from the magnetic resonance device may directly or indirectly provide information about the composition of the material and the output may be used to determine one or more components (whether they be atoms, compounds or more complex atomic structures) that make up the material.

In the context of the example embodiments described herein, it will also be understood that references to a “magnetic resonance device” encompass a device that is capable of operating in a mined material upgrading context. That is, the componentry, location and ‘tuning’ of the device is such that it can operate effectively in a mined material upgrading circuit.

The magnetic resonance device 106 is capable of taking continuous readings ‘on the fly’ of successive parcels of particles as each parcel passes along the conveyor belt 102. Upon taking a reading of a parcel, the device 106 sends a data signal indicative of the received electromagnetic radiation to a data processing device 108 (in the form of a computing device), which is arranged to receive the signal and process the signal to provide an indication of the quality/quantity of copper ore present in the parcel of particles and also provide information on the type of copper ore that is predominantly present in the parcel of particles.

That is, the magnetic resonance device is connected via an appropriate network or link to a computing device arranged to interpret the output of the magnetic resonance device and consequently direct a conveyor/sorter (or other appropriate device) to divert particles or parcels of particles appropriately.

It will be understood that while FIGS. 1 and 2 illustrate the data processing device 108 being physically proximate to the magnetic resonance device 106, the data processing device may be integrally located with the device 106, or may be located in a remote location. Such variations are within the purview of a person skilled in the art.

By identifying the amount and type of copper ore present (e.g. chalcopyrite, bornite, chalcocite or covellite) in the parcel of particles, a decision may be made about the grade of the ore in the parcel or more particularly, whether the ore is suitable for recovery without further upgrading.

In the context of the present specification, a copper ore which contains over 0.6% copper is considered a high quality ore that is commercially viable to recover copper from. A copper ore which contains less than 0.3% copper is considered barren and is not (as at the priority date of this application) considered economically viable to recover copper from. Copper ores that contain between 0.3 to 0.6% copper ore are considered intermediate ores, which may in certain circumstances benefit from secondary analysis (either in bulk or by fragment) to determine whether such secondary analysed parcels or fragments are economically viable to recover copper from, or whether they should be considered barren.

In the embodiments shown in FIGS. 1 and 2, the data processing device 108 is connected to a redirection device 110, arranged to sort copper ore fragments 104 depending on the result provided by the magnetic resonance device 106. The redirection device 110, in the context of the present specification, takes the form of a moveable platform which is arranged to sort the copper ore particles 104 into one of three ‘collections’, namely a barren collection 112, an intermediate collection 114 and a floatation (i.e. recoverable) collection 116.

In yet another embodiment, the output may be utilised to calculate a ‘mean’ or average value for the copper content of a plurality of parcels over a predetermined time.

In more detail, where parcel size is small (less than 100 particles) or where the grade of the parcel is extremely close to the desired cut-off point, losses can occur due an incorrect classification of a parcel as ‘barren’ when in fact the parcel contains a copper content that is above the cut-off point.

One way to ameliorate this problem is to take an average or ‘mean’ reading of a plurality of parcels as they pass through the sorter, to estimate the ‘mean’ grade of the material passing through the sorter and thereby sort individual parcels not on a reading of the copper content of each parcel per se, but on a mean reading across a plurality of similar parcels.

In other words, an analytical tool such as a cumulative sum chart can be utilised to determine when a change in mean grade was developing (i.e. from barren to floatation or vice versa). The operation of the sorter can then be controlled by the above described decision-making strategy. It will be understood that the strategy can be tuned on the basis of the actual variability in mean grade experienced in practice in a particular site.

While not shown in FIGS. 1 and 2, it will be understood that the magnetic resonance device 106 may also be utilized to determine the type of ore in the parcel, which may also be utilized to further sort each parcel of particles. For example, Chalcopyrite, when pure, has a copper content of 34.5%, whereas Chalcocite, when pure, has a copper content of 79.8%. Therefore, mined ore rich in Chalcocite, may be sent to be upgraded and to recover the copper metal, whereas, depending on the mining application, ore that contains Chalcopyrite may, in some circumstances, be classified as barren.

It will also be understood that while the magnetic resonance device described herein includes multiple components, the device should not be limited to encompass only an apparatus or system that includes multiple components, but should also be construed to include a device or scanner that is a unitary or “one-piece” device, where all components, such as but not limited to the data processing component, are provided in a unitary device with the magnetic resonance device.

Referring now to FIGS. 3 to 6, there is shown a mined material upgrading circuit generally denoted by 200, including a plurality of sorting stages, which, taken together, result in the upgrading of particles of a copper ore and the subsequent recovery of the copper metal. The mining circuit 200 is particularly suited to the upgrading of copper bearing sulfides such as chalcopyrite, bornite, chalcocite and covellite, but may be used to upgrade other copper ores.

Referring to FIG. 3, the circuit 200 receives a feed material 202 in the form of particles of copper ore. A predefined number of particles (as previously described) are defined as a parcel 204, and each parcel is transported to a magnetic resonance sorting device 206 (such as the sorter 100 described with reference to FIGS. 1 and 2), which analyzes the constituents of the parcel of copper ore particles and determines whether the copper ore parcel, as a whole, may be classified as a low (or barren) grade parcel 208, an intermediate grade parcel 210 or a high (or flotation) grade parcel 212.

Barren parcels 208, which are not economically viable to upgrade, are sent to a tailings pond/storage area 220.

Flotation grade parcels 212, which are economically viable to recover copper metal from, are sent to a mill stage 216 and subsequently to a flotation treatment stage 218, each one of stages 216 and 218 being designed to recover the copper metal from the ore.

Intermediate grade parcels 210 are sent to a second parcel sorter 214a. Prior to being sent to second parcel sorter 214a, the parcel may be sub-divided into two or more smaller parcels by a parcel definition device 211. Different blocks in a mine have different mineralogy type ores so the parcel definition device is utilised to optimize the parcel size, so that, in turn, the bulk sorter is always applying the optimum parcel size.

In more detail, the parcel definition device includes an appropriate sensor (such as but not limited to a magnetic resonance device described with reference to FIGS. 1 and 2) that determines the type of ore or an indication of the mineralogy of the ore. In one embodiment, the parcel definition device does not use a separate sensor, but instead utilises data collected by the magnetic resonance device. Such variations are within the purview of a person skilled in the art.

While not explicitly shown in FIGS. 3 to 6, it will also be understood that the parcel definition device includes or is able to communicate with appropriate hardware (and in some embodiments, software) to carry out the function of determining the type of ore or an indication of the mineralogy of the ore. The appropriate hardware/software includes (but is not limited to) a processor, appropriate memory (volatile or non-volatile), and at least one storage module arranged to contain both program instructions to operate the parcel definition device 211 and also a database (in the form of a table, library or other appropriate structure) which contains information regarding an optimal parcel size for a particular type of ore or the indicative mineralogy of the ore.

Depending on the type of ore or the indicative mineralogy of the ore, the parcel definition device 211 compares the type of ore or the indicative mineralogy of the ore to data that exists in the database.

Ore that is predominantly of one type is separated into a different parcel size by the parcel definition device 211 than an ore with another type of mineralogy. In other words, the parcel definition device 211 dynamically changes the parcel size depending on the sensor input and the database of parcel sizes optimized for the specific sensor input.

Other inputs to the parcel definition device 211 may include the speed of the belt, or the size of the ores. For example, the parcel definition device may include or may be in communication with an optical or infra-red camera which uses image recognition software to estimate the average size of the parcels and/or particles on the belt. This information may be used in conjunction with the type of ore or the mineralogy of the ore to dynamically vary the parcel size to correspond with an optimum parcel size for bulk sorting.

Returning to the circuit of FIG. 3, the second parcel sorter 214a works on the same magnetic resonance principle as the sorting device 206, but is generally arranged to scan smaller parcels. Generally, a smaller parcel is defined as a parcel that is a fraction (e.g. approximately 50% or less) of the parcel size that was provided to the sorting device 206.

For example, if the original parcel size passed through the sorting device 206 was 500 kg, the smaller parcel size to be passed through the second particle sorter may be 250 kg, or 100 kg, or 50 kg, etc. It will be understood that any suitable fraction may be chosen, depending on the parameters of the mining circuit, knowledge about the ore, etc. For example, where a much higher resolution is desired for the second parcel sorting stage, the smaller parcel may be 5% of the original parcel size. That is, for an original parcel size of 500 kg, a smaller parcel size of 25 kg may be provided to the sorter 214a.

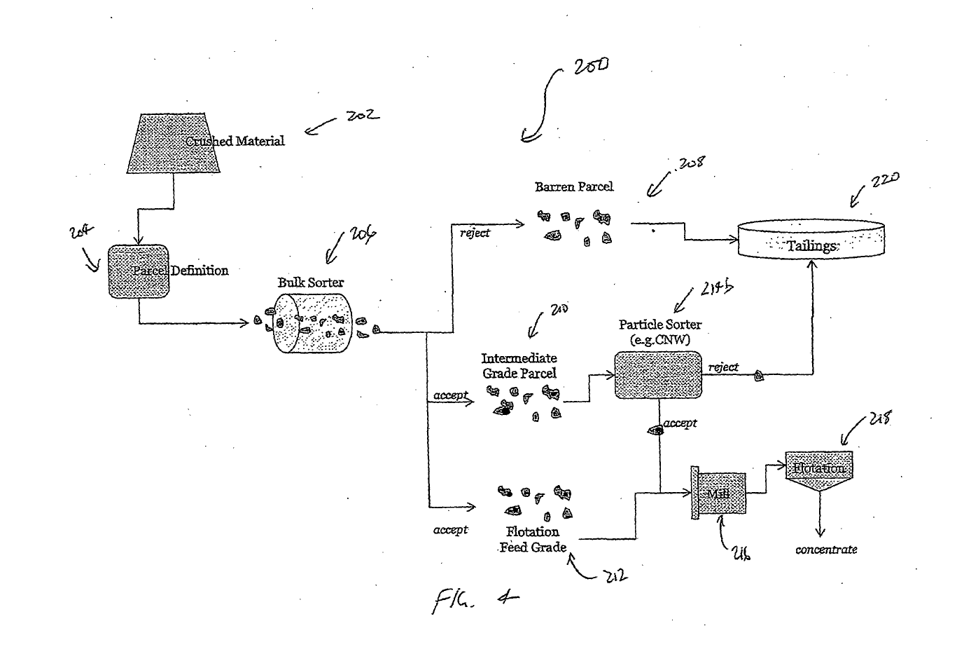

Referring now to FIG. 4, there is shown a mined material upgrade circuit that is identical to the circuit outlined in FIG. 3, expect that the circuit of FIG. 4 utilizes a particle sorter 214b. That is, rather than sort parcels of particles, the particle sorter 214b sorts individual particles. In one example, the particle sorter 214b utilizes either a radio frequency or a microwave technique to individually probe each particle to provide a higher resolution by virtue of analyzing each of the ore particles in the parcel and also to identify the type of ore predominantly present in each particle in the parcel.

An example of a radio frequency technology that may be utilized to individually probe each particle is described in pending PCT application PCT/AU2010/001712, entitled “Sorting Mined Material”, which is incorporated herein by reference. An example of a microwave technology that may be utilized to individually probe each particle is described in pending PCT application PCT/AU2006/001561, entitled “Method of Determining the Presence of a Mineral within a Material” which is also incorporated herein by reference.

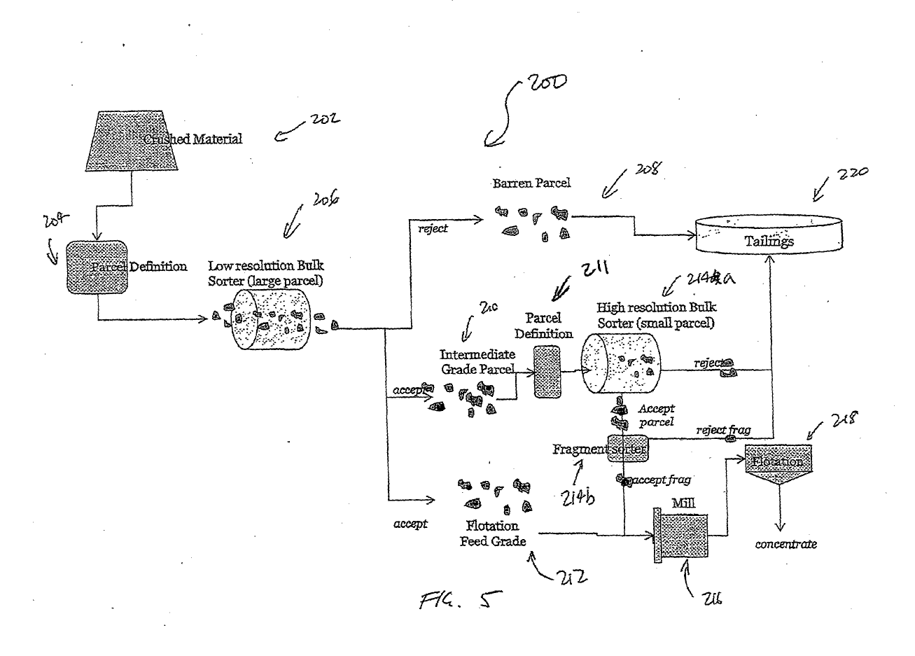

Referring now to FIG. 5, there is shown a mined material upgrade circuit which utilizes both the smaller parcel sorter 214a of FIG. 3 and the particle sorter 214b of FIG. 4. As can be seen in FIG. 5, intermediate parcels are firstly processed through the smaller parcel sorter 214a to further separate barren parcels from flotation grade parcels. Flotation grade parcels are then further sorted by the particle sorter 214b by analyzing individual particles to separate barren particles from floatation grade particles. The use of an intensive sorting process ensures that very few barren particles, if any, are sent for recovery to the milling and floatation stages. As with the embodiment shown with reference to FIG. 3, the embodiment of FIG. 5 includes a parcel definition device 211, which, prior to being sent to second parcel sorter 214a, sub-divides the parcel into two or more smaller parcels by a parcel definition device 211.

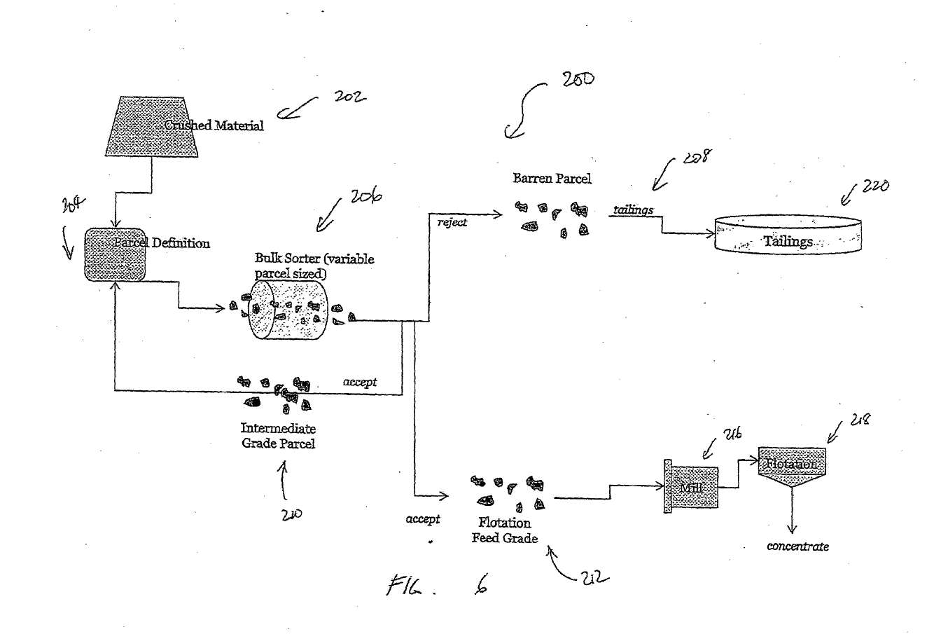

Referring now to FIG. 6, there is shown an alternative embodiment of a mined material upgrading circuit. In FIG. 6, there is no parcel sorter 214a or particle sorter 214b. Instead, intermediate grade parcels are divided into smaller parcels, before being reintroduced into sorter 206. That is, sorter 206 operates in a variable manner, accepting and processing parcels of different sizes, depending on the desired resolution. To put it another way, when parcels are sent through a first time, the sorter 206 is run at a lower resolution (i.e. larger parcel sizes are passed through), but parcels that have already been labeled as intermediate grade are divided into smaller sub-parcels by passing them through the parcel definition device 204, so that the sorter 206 can run at a higher resolution (i.e. smaller parcel size). The parcel definition device 204 of FIG. 6 operates in the same manner as the parcel definition device 211 described with respect of FIGS. 3 and 5.

It will be understood that the second run through the sorter 206 may occur immediately (i.e. intermediate grade parcels may be divided and re-introduced immediately) or alternatively, the intermediate grade parcels may be collected and stockpiled, to be passed through the sorter 206 at a later time.

Alternatively, instead of or in addition to dividing the intermediate grade parcels, the intermediate grade parcels may be mixed with mined material that is yet to be sorted before being run through the sorter 206. The action of mixing the parcels to form new parcels may, in certain situations, ameliorate the need to vary the size of the parcels, as the act of mixing may change the overall composition of the parcel and result in new parcels that contain over 0.6% copper or below 0.3% copper.

Such variations in the manner in which intermediate grade parcels are reintroduced into the sorter 206 are within the purview of a person skilled in the art.

The provision of a device in accordance with FIGS. 1 and 2 (which is utilized as one component in the mining circuits of FIGS. 3 to 6) provides a number of advantages to the upgrading of copper ore fragments.

Firstly, the most energy, time and cost intensive stages of any copper ore upgrading circuit are the recovery stages, whether they are dry or wet stages, as opposed to the sorting/upgrading stages.

In the example circuits of FIGS. 3 to 6, the mill stage 216 and the flotation treatment stage 218 are the most energy, time and cost intensive stages of copper extraction and refinement from ore. Therefore, only parcels of particles that are of a suitable standard should be provided to stages 216 and 218, to maximize the efficiency of the recovery stages.

Secondly, in addition to better determining the quality of ore in a parcel of particles, the apparatus of FIGS. 1 and 2 is also capable of determining the type of ore in each of the particles that make up the parcel. This in turn allows the upgrading circuit to be tuned so that parcels of particles are sent to a recovery stage (such as the mill 216 and the floatation treatment stage 218) that provides the best result. That is, the highest grade copper for the lowest energy, time and cost for the type of ore mined.

For example, sulfide ores tend to be recovered using a floatation technique (such as the flotation treatment stage 218), since sulfide ores that are naturally high in native copper are generally more resistant to treatment with wet chemical techniques such as sulfuric acid leaching.

In contrast, some sulfide ores can be leached using a bacterial oxidation process to oxidise the sulfides and thereby allow for simultaneous leaching with sulfuric acid to a copper sulfate solution, which in turn can be recovered using a solvent extraction technique.

In other words, more efficient (i.e. cost effective) recovery is achieved where detailed knowledge regarding the composition of the copper ore can be determined ‘on the fly’. This allows mined material to be upgraded and the metal recovered efficiently, with little regard to any changes in the composition of the ore as new parcels of ore are passed through the circuit. In turn, this allows a copper ore upgrading circuit in accordance with the embodiments described herein to accept any prima facie suitable copper ore for upgrading and recovery, without the need to spend an appreciable amount of time ‘tuning’ the circuit to suit a particular ore.

A circuit in accordance with the embodiment described herein also reduces or largely ameliorates the need to “pre-test” mined copper ore prior to providing the ore to the circuit.

By providing a device in accordance with FIGS. 1 and 2 which is capable of both determining the quality of a parcel of particles and the type of copper ore present, a high efficiency upgrading and recovery circuit can be provided, which allows copper ore to be upgraded and copper metal recovered in an efficient and cost effective manner.

It will be understood that while the description of an embodiment of the invention focuses on the upgrading of copper ores with particular reference to copper sulfide minerals, the broader invention is not limited to the upgrading of copper sulfide minerals. Indeed, the methods and apparatuses described herein may be used to upgrade other copper phases, such as copper-arsenic phases including enargite and ten nantite/tetrahedrite.

It will also be understood that while the embodiment described herein refers to the sorting and upgrading of copper ores and the recovery of copper metal, the broader inventive concept may find use in the sorting and upgrading of any type of material that contains copper, including man made materials. That is, the invention may find use in recovering copper from alloys or other man-made compositions, which may be ‘scrap’ from building waste, scrapped appliances, or other man-made sources.

It will also be understood that the particular upgrading circuit described herein refers to one implementation of a mined material upgrade circuit that includes a magnetic resonance device, but that the broader inventive concept described herein should not be limited only to the circuits described herein.

That is, the bulk sorter described in the present application is a magnetic resonance sorter, but in the context of the broader invention the bulk sorter may use any suitable analytical technique to determine the basis for sorting parcels of material being processed in the bulk sorting steps. In particular the bulk sorter technology may be based on the radio frequency and/or microwave technologies described for the fragment sorters of the two PCT applications referred to in paragraph 55 above.

Other analytical techniques for the bulk sorting step may include, by way of example, x-ray fluorescence, radiometric, electromagnetic, optical, and photometric techniques.

The applicability of any one or more of these (and other) techniques will depend on factors relating to a particular mine ore or a section of the mine to be mined.

1. A method of sorting a parcel of ore comprising the steps of first sorting the parcel of ore into one of at least two grades based on a characteristic of the parcel of ore, and a second sorting step wherein the parcel of ore is further sorted.

2. A method in accordance with claim 1, wherein the second sorting step comprises the intermediate step of dividing the parcel into at least two sub-parcels of ore and sorting at least one of the at least two sub-parcels.

3. A method in accordance with claim 2, wherein the intermediate step of dividing the parcel into at least two sub-parcels includes the step of determining at least one of the type of ore and the mineralogy of the ore, and dividing the parcel on the basis of the determination.

4. A method in accordance with claim 3, wherein the step of determining the at least one type of ore and the mineralogy of the ore comprising the further step of utilising an algorithm to determine at least one of the type of ore and the mineralogy of the ore.

5. A method in accordance with claim 4, wherein the algorithm utilises a predetermined database of values as an input to determine the required sub-division of the parcel.

6. A method in accordance with claim 4, wherein the algorithm utilises at least one of the size of the parcel of particles and a speed at which the parcel of particles is progressing along a conveyor belt as inputs to determine the required sub-division of the parcel.

7. A method in accordance with claim 2, wherein the second sorting step includes the step of classifying at least one of the at least two sub-parcels of ore into one of a plurality of grades.

8. A method in accordance with claim 7, wherein the second sorting step comprises the additional step of providing at least one of the at least two sub-parcels to the first sorting step.

9. A method in accordance with claim 1, wherein the plurality of grades includes a barren grade, an intermediate grade and a high grade.

10. A method in accordance with claim 9, wherein the sorting step includes the further step of sending the ore to a recovery stage if the ore is of a high grade.

11. A method in accordance with claim 9, wherein the sorting step includes the further step of sending the ore to a tailings storage area if the ore is of a barren grade.

12. A method in accordance with claim 1, wherein the first sorting step includes exposing the at least one parcel to an electromagnetic field and measuring the resultant emitted electromagnetic radiation from the parcel of ore, wherein the resultant electromagnetic radiation is indicative of a characteristic of the parcel of ore.

13. A method in accordance with claim 1, wherein the second sorting step includes at least one of utilising a magnetic resonance technique, a microwave technique and a radio frequency technique.

14. A method in accordance with claim 1, wherein the characteristic is at least one of the type of ore and the relative concentration of a metal in the ore.

15. A method in accordance with claim 1, wherein the ore is a copper containing ore.

16. A method in accordance with claim 1, further comprising the step of altering the number of particles in the parcel of ore dependent on at least one parameter.

17. A method in accordance with claim 16, wherein the at least one parameter is a function of the average grade value over a predetermined period of time.

18. An apparatus for sorting a parcel of ore comprising a first sorting device arranged to sort a parcel of ore into one of at least two grades based on a characteristic of the parcel of ore, and a second sorting device wherein the parcel of ore is further sorted.

19. An apparatus in accordance with claim 18, further comprising a parcel definition device arranged to divide the parcel into at least two sub-parcels of ore, wherein the second sorting device sorts at least one of the at least two sub-parcels.

20. An apparatus in accordance with claim 19, wherein the parcel definition device is in communication with at least one sensor arranged to determine at least one of the type of ore and the mineralogy of the ore, wherein the parcel is divides on the basis of the determination.

21. An apparatus in accordance with claim 20, wherein the parcel definition device is in communication with at least one processor that utilises an algorithm to determine at least one of the type of ore and the mineralogy of the ore.

22. An apparatus in accordance with claim 21, wherein the parcel definition device is in communication with at least one database which is accessible via the at least one processor, the database including a predetermined database of values utilised by the processor as an input to determine the required sub-division of the parcel.

23. An apparatus in accordance with claim 21, wherein the parcel definition device is in communication with at least one additional sensor arranged to provide data to the processor, the at least one additional sensor providing data indicative of at least one of the size of the parcel of particles and a speed at which the parcel of particles is progressing along a conveyor belt, wherein the data is utilised as an input by the processor to determine the required sub-division of the parcel.

24. An apparatus in accordance with claim 23, wherein the second sorting device classifies at least one of the at least two sub-parcels of ore into one of a plurality of grades.

25. An apparatus in accordance with claim 24, wherein the second sorting device is arranged to feed back at least one of the at least two sub-parcels to the first sorting device.

26. An apparatus in accordance with claim 22, wherein the plurality of grades includes a barren grade, an intermediate grade and a high grade.

27. An apparatus in accordance with claim 26, wherein the apparatus is arranged to provide the sub-parcel of ore to a recovery apparatus if the ore is of a high grade.

28. An apparatus in accordance with claim 26, wherein the apparatus is arranged to provide the sub-parcel or ore a tailings storage area if the ore is of a barren grade.

29. An apparatus in accordance with claim 18, wherein the first sorting device includes a magnetic resonance system arranged to expose the at least one parcel to a magnetic field and measure the resultant emitted electromagnetic radiation from the parcel of ore, wherein the resultant electromagnetic radiation is indicative of a characteristic of the parcel of ore.

30. An apparatus in accordance with claim 18, wherein the second sorting device is one of a magnetic resonance sorting device, a microwave sorting device and a radio frequency sorting device.

31. An apparatus in accordance with claim 18, wherein the characteristic is at least one of the type of ore and the relative concentration of a metal in the ore.

32. An apparatus in accordance with claim 18, wherein the ore is a copper containing ore.

33. An apparatus in accordance with claim 18, further comprising a parcel definition device arranged to alter the number of particles in the parcel of ore dependent on at least one parameter.

34. An apparatus in accordance with claim 33, wherein the at least one parameter is a function of the average grade value over a predetermined period of time.

35. A mining circuit including an apparatus in accordance with claim 18.

36. A mine including an apparatus in accordance with claim 18.

37. A method of sorting copper ore comprising the steps of exposing a plurality of particles of copper ore to a magnetic field and measuring the resultant emitted electromagnetic radiation to determine at least one of the type of copper ore or the relative concentration of copper in the copper ore of the plurality of particles, and sorting the plurality of particles of copper ore on the basis of the determination.

38. A method in accordance with claim 37, comprising the further step of classifying the plurality of particles into one of a plurality of grades.

39. A method of sorting copper ore in accordance with claim 37 wherein the sorting step includes the further step of performing an additional sorting step if the plurality of particles of copper ore is of an intermediate grade.

40. A method of sorting copper ore in accordance with claim 39, wherein the additional sorting step comprises iterating the method steps of claim 37 utilising the plurality of particles of copper ore of an intermediate grade.

41. A method of sorting copper ore in accordance with claim 37, comprising the further step of, upon determining the type of copper ore, sending the copper ore to at least one of a plurality of upgrading stages on the basis of the type of copper ore.

42. A method of sorting copper ore in accordance with claim 37, further comprising the step of altering the number of particles in the plurality of particles of copper ore dependent on at least one parameter.

43. A copper ore sorting apparatus comprising a magnetic field generator arranged to expose a plurality of particles of copper ore to an electromagnetic field, a detector arranged to measure the resultant emitted electromagnetic radiation from the particles, and a processing device arranged to receive the measurement from the detector and determine at least one of the type of copper ore or the relative concentration of copper.

44. A copper ore sorting apparatus in accordance with claim 43, further comprising a sorting device arranged to receive an output of the at least one of the type of copper ore or the relative concentration of copper in the at least one particle and sort the at least one particle of copper ore into a plurality of collections.

45. A copper ore sorting apparatus in accordance with claim 44, wherein the plurality of collections include a low grade collection, an intermediate grade collection and a high grade collection.

46. A copper ore sorting apparatus in accordance with claim 45, wherein a low grade collection includes copper ore with a copper concentration of about or below 0.3% by weight.

47. A copper ore sorting apparatus in accordance with claim 45, wherein a high grade collection includes copper ore with a copper concentration of about or above 0.6% by weight.

48. A copper ore sorting apparatus in accordance with claim 45, wherein an intermediate grade collection includes copper ore with a copper concentration of between approximately 0.3% to 0.6% by weight.
